(19) United States
(12) Patent Application Publication
(10) Pub. No.: US 2007/0284845 A1
(43) Pub. Date: Dec. 13, 2007

(54) Wheel Chair with Drive Support and Force Sensor for Use Therewith

(76) Inventors: Gijsbertus Franciscus Roovers, Goirle (NL); Bastiaan Andreas d'Herripon, Goirle (NL)

Correspondence Address: MICHAELSON & ASSOCIATES, P.O. BOX 8489, RED BANK, NJ, 07701, US

(21) Appl. No.: 11/596,484

(22) PCT Filed: May 12, 2005
(86) PCT No.: PCT/NL05/00362

§ 371 Date: Jul. 6, 2007

(30) Foreign Application Priority Data
May 12, 2004 (NL) 1026178

(51) Int. Cl. B62M 1/20

(52) U.S. Cl. 280/250.1; 180/315

(57) ABSTRACT

The invention relates to a wheelchair, provided with a drive system comprising a controller, an energy source and driving motors and sensors which can be coupled thereto for measuring a control signal for the driving motors. The invention also relates to a hand force sensor comprising a force sensitive sensor part and a spring system which, during use, transmits hand force from a grip or wheel on which the hand force is applied to the force sensor.

The invention relates to a wheelchair with drive support.

There are wheelchairs which are manually powered, either by the chair occupant driving the wheels with the aid of push rims, or by a person behind the chair pushing the chair via push bars. In addition thereto, there are wheelchairs that are equipped with motors providing the complete drive power and which are operated by the chair occupant with operating elements, for instance a joystick. Furthermore, there are wheelchairs which are also provided with driving motors but whose driving motors provide only a part of the drive power, while the remaining part is provided by the chair occupant or the person pushing.

In these electric wheelchairs, a drive system is built-in which can only be used in fixed configuration with a joystick or speed-control. To this end, these wheelchairs have an accumulator set, a motor controller and an operating element. These parts are interconnected by wiring. This is disadvantageous for assembly, for maintenance and cleaning the wheelchair and for adapting the wheelchair to the desires of other users.

In some systems, the entire drive and operating system is built-in in the wheel. This has the limitation that the system cannot be easily changed into a pressure force supported system or a system operated by the chair occupant himself by means of a joystick.

To an increasing extent, these chairs are used in institutes where it would be advantageous when they could be used by several people. This is possible when the wheelchairs can be easily adapted to the desires of various people.

Existing electric wheelchairs utilize a drive system built onto the chair. These systems consist of driving motors, direct drive or, in combination, a mechanic reduction, a battery set, a motor control and an operating element. These parts are fixedly interconnected via wires and, in fact, undetachably integrated in the wheelchair.

In the current technique, different systems are used for controlling an auxiliary support for wheelchairs. A known method utilizes a control by means of a hand-adjustable regulator for controlling the motor, optionally in combination with an adjustable setting for the maximum speed, separate from the adjustable regulator.

Another method is described in U.S. Pat. No. 5,732,786. This system utilizes a handgrip slideable in axial direction, which is placed on the push bar of the wheelchair. A potentiometer is connected to the grip, which potentiometer produces a force-dependent and position-dependent signal. Stops are arranged in the grips, with a spring resting against these stops. The control signal thus generated by the grip is position-dependent of the grip. The drive power of the chair depends on the compression of the springs resting against a stop, and on the related displacement of the potentiometer which produces the motor control signal as a result of the pushing or pulling movement. A neutral zone exists depending on the preset bias of the spring. In the operation of the sensor, the output of the sensor is Zero (0) when the spring rest with two ends against the stops, when the spring is compressed and is thus cleared from one of the two stops, a displacement of the potentiometer is effected so that a control signal is obtained.

A second embodiment of a hand force sensor is shown in U.S. Pat. No. 3,225,853 of Norton (1962). This embodiment shows a slideable, linear potentiometer to which the grip is attached. The potentiometer regulates the motor speed, while a switch is operated for reversing the direction of revolution of the motor. The grip is provided between two springs so that the control signal of the motor becomes proportional to the generated spring force and the displacement of the potentiometer slide occurring as a result thereof.

There are various systems with which the force on the push rim on the large rear wheels of the wheelchair is measured. One such system is for instance described in U.S. Pat. No. 6,302,226B1. This system utilizes a sensor which converts, via a potentiometer, a hand force acting on the push rim into an electric control signal for the controller. These components are all fixedly interconnected.

The invention contemplates providing a wheelchair of the type described in the opening paragraph, wherein at least a number of the drawbacks of the known wheelchairs are prevented while maintaining the advantages thereof. To that end, a wheelchair according to the invention is characterized by the features of claim 1.

To improve the adjustability of the electric wheelchair, the invention suggests a modular structure of the drive system and connecting of the components to the controller with plugs or in a wireless manner for instance via a bus system known from the field of electronics. Such a bus system has the advantage that wiring required thereto can be of relatively simple design.

If wireless components are utilized, they each contain a unique code so that no interference occurs with, for instance, other wheelchairs in the direct vicinity that are equipped with such a system. Preferably, a basic drive module comprises a battery set, a driving motor and a controller. Because of the magnitude of the electric currents these components are preferably directly interconnected.

Operating elements may for instance be a joystick and/or hand force sensors on the wheels and/or the push bars on the back of the chair and/or a suppression circuit. The sensors transmit their control information to the controller via a signal wire, or in a wireless manner. The controller has a transceiver with which the sensor is recognized and the sensor information is used for controlling the drive system. Preferably, the controller is designed such that the required information is stored in the basic unit for cooperation with different, preferably all, modular components. A wheelchair can easily be altered by exchanging the operating elements, for instance by replacing a joystick sensor with hand force sensors on the push bars.

In this application, a wheelchair drive system is described which is suitable to be quickly adapted to the needs of different users. The drive system comprises modular units such as a controller, driving motors, push force sensors (push force and push rim force), joystick operation and/or battery sets.

Preferably, a motor drive system comprising a battery, controller and driving motors cooperates wirelessly with operating components. The operating components are recognized via an identification code only by their own controller so that other wheelchairs in the vicinity are not activated.

One objective of the invention is to provide a wheelchair with a drive system suitable to be utilized in a simple and modular manner. According to the invention, such a drive system has a modular structure, comprising a controller which can cooperate with different, target-group dependent components. The controller can cooperate with different types of motors, with different battery sets, with different controlling elements and has provisions for different peripherals such as electric position adjusting elements for the seat and backrest of the wheelchair and their operating means, GPS system and wireless alarm function and position indicator, storage of personal and medical data of the owner, light, direction indicators, alarm lights, beepers for reversing and the like. To that end, the controller can be provided with a receiver for wireless signals, and the controller is provided with the necessary analogous and/or digital inputs and outputs and the like. The receiver can communicate with the different sensor modules via a number of channels. What can be prevented via the channel selection is that different wheelchairs operating in the direct vicinity experience interference due to a transmitter of another wheelchair. Building-in a GPS system and alarm function in the controller is of particular advantage because, especially in the case of a self-powered chair, in case of emergency, the chair can be rapidly localized by means of the GPS and the alarm function and the position indicator, and due to the personal data, emergency services can offer the specific help more rapidly.

It is preferred that the modular components to be coupled cooperate with the controller, such as hand force sensors in the grips of the push bars and of push rims on the wheels and of a joystick operation of the electro-drive. Especially for force sensors of the push rims on the wheels it is advantageous to equip these with a wireless signal transmission because they are mounted on the revolving part of the wheel and the motors and controller are placed on the chair. To that end, the modular components can have a transmitter with an identification code so that the controller can recognize the type of control and can set the associated parameters, for instance for speed limitation or the amplification factor belonging to a particular sensor or user of the wheelchair. Thus, the structure of the wheelchair becomes very simple, vulnerable and interfering wire connections can be omitted and the sensor can be removed in a simple manner for conversion or to be cleaned or renovated.

It is preferred that in the controller, a control characteristic can, for instance, be adapted by selecting different programs with preset parameters.

For a push force supported drive system, push force sensors in the grips are utilized, and a relatively small, inexpensive and light battery set. For a version supported by push rims, force sensors on the push rims are utilized which control the driving motors. For embodiments that are to be self-powered, for instance a joystick drive and a large battery set are utilized because, as a rule, for an independently moving chair, a greater range and capacity are required than for a push (push rim) force supported version. Naturally, these are only examples of possible embodiments.

For a push force supported version, preferably, a push force sensor is used which is maintenance free, robust and durable and inexpensive, having the entire range to measure both push force and pull force. The system can operate with a push force sensor, which controls one or more motors. In a push force supported chair, preferably, two push force sensors are used and two motors, controlled separately from each other which are each placed on one side of the chair. The push force sensor in the left-hand grip controls the left-hand motor, and the right-hand grip controls the right-hand motor. When a push force is applied, the motor is powered in forward direction, when a pull force is applied, in a backward direction of revolution. Naturally, control can also take place depending on both the absolute push forces and the mutual difference. Through this method of control, the chair intuitively follows the objectives of the person pushing, and with the chair, corners will be easier to negotiate. The same method of control can also be used for a push rim-supported wheelchair wherein the chair occupant himself provides, with his arms, the primary drive power.

A sensor according to the invention is preferably based on force measurement by means of strain gauges. These are for instance placed on a force measurement element fixedly disposed in an inside tube. The grip slides over the inside tube and applies a push force to the sensor via a biased spring set. The point of pressure of the grip against the spring is preferably adjacent the middle of the spring so that in push and pull direction the same deflection and control signal is possible. This is advantageous but can also be carried out with the point of engagement not being in the middle of the spring, so that a different characteristic occurs in push and pull direction. The advantage of this manner of construction is that there is no clearance between grip and the sensor, giving the user a sense of robustness and quality.

The deflection of the sensor under force is extremely slight, typically some tens of micrometers. To protect the sensor from overload, the grip is bound with mechanical stops. As springs have been placed between the force sensor and the grip, with these stops the maximum force on the sensor is limited. When great push or pull forces are applied, the grip is bound from deflecting further against stops on the inside tube and thus prevents the sensor from being overloaded. Due to these mechanic stops, the sensor can be designed such that great sensitivity is obtained without there being the danger of overload and, possibly, the sensor bending plastically thus rendering it unusable.

The deflection of the grip is defined by the spring used between the grip and the sensor and the deflection allowed for the grip. A deflection of 1 to 2 mm in pushing and pulling direction is an advantageous compromise between the sensed firmness and the simple construction with tolerances which can be realized in a simple manner. The characteristic of the sensor can be adapted by the controller for adjusting the driving characteristic to the desires of the users and can, for instance, be set to be energy-conserving or to give a strong support. In the controller, the threshold value is entered electronically or in software which is to be exceeded by the output of the sensor before a control of the supporting force is effected. In the controller, for a further refinement, a damping can be effected on the control signal, and the characteristic of the response can be determined via progressive, degressive or linear control characteristic. The controller can store several predetermined characteristics which can be selected and activated by the user via a menu.

### DESCRIPTION OF THE DRAWINGS

FIGS. 1A-C show, in side view, three embodiments of a wheelchair according to the invention;

FIGS. 2A-C schematically show, in top plan view, an undercarriage of the wheelchairs according to FIGS. 1A-C with drive system;

FIG. 3 shows, in perspective view, a hand force sensor according to the invention;

FIG. 4 shows a hand force sensor according to FIG. 3, in longitudinal cross-section;

FIG. 5 shows the sensor output of the hand force sensor;

FIG. 6 shows an example of the sensor output with characteristic adapted by the controller;

FIG. 7 shows a block diagram for connection of different modules wherein the correct driving parameters are set via recognition of the type of sensor;

FIGS. 8-10 show a sensor according to FIGS. 3, 4 and 11 in cross-sectional view, in three positions;

FIG. 11 shows, in perspective view, a wheel for a wheelchair according to the invention, with a hand force sensor; and

FIG. 12 shows, in perspective view, a wheel for a wheelchair according to the invention, with a hand force sensor.

In this description, identical or corresponding parts have identical or corresponding reference numerals. The embodiments are only shown by way of example and are only schematically represented. Combinations of parts of exemplary embodiments shown are also understood to fall within the inventive concept. Furthermore, many variations are possible within the framework of the invention as outlined by the claims.

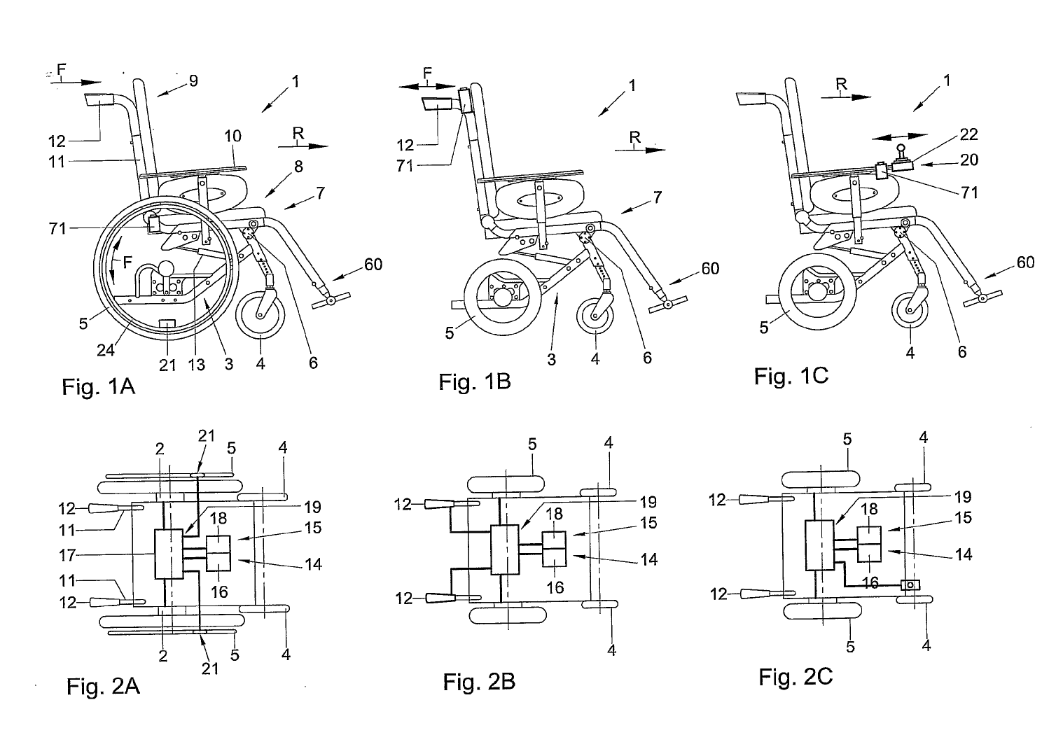

FIG. 1 shows, in side view, three embodiments of a wheelchair 1 according to the invention, with different control components and sensors 21. In all of the cases, the basic structure of the wheelchair 1 is only shown by way of example and is substantially the same. The wheelchair comprises a frame 3 with two relatively small front wheels 4 and two relatively large rear wheels 5. Via a pivot 6 extending approximately horizontally, located adjacent the back of the knee of a user seated in the wheelchair 1, the frame 3 is connected to a seat part 7. In this embodiment, the seat part 7 comprises a seat 8 with feet rest 60, a back rest 9 and two arm rests 10. Behind the back rest 9, two push bars 11 are provided, terminating in grips 12 with which the wheelchair can be pushed forward by an assistant. Below the seat 8, a gas spring 13 is provided, resting on the frame 3 and providing a cushioned spring characteristic for the seat part 7.

The frame bears a basic component 14 of a drive system 15 according to the invention (FIG. 2), comprising a battery (set) 16, a drive unit 17 and a controller 18. The drive unit 17 comprises one or, preferably, two electric motors 2 for driving the wheels. Here, the battery (set) 16 provides the required voltage. The controller 18 is provided with a series of coupling means 19 as will be elucidated further, for system components such as operating means 20 and sensors 21 which can be coupled to the coupling means 19 via plug connections and/or transmitter/receiver systems. The controller 18 is provided with at least one algorithm and memory means. The algorithm is designed to recognize coupled system components such as operating elements 20 and sensors 21 and, based thereon and in particular based on signals thereof and/or control profiles stored in the memory means, for controlling the motors. The control profiles can indicate, for instance, a relation between a change in an input signal from a sensor, or differences in the magnitude of such signals and a change in power supplied to the or a motor. Also, for instance, threshold values for activation can be set.

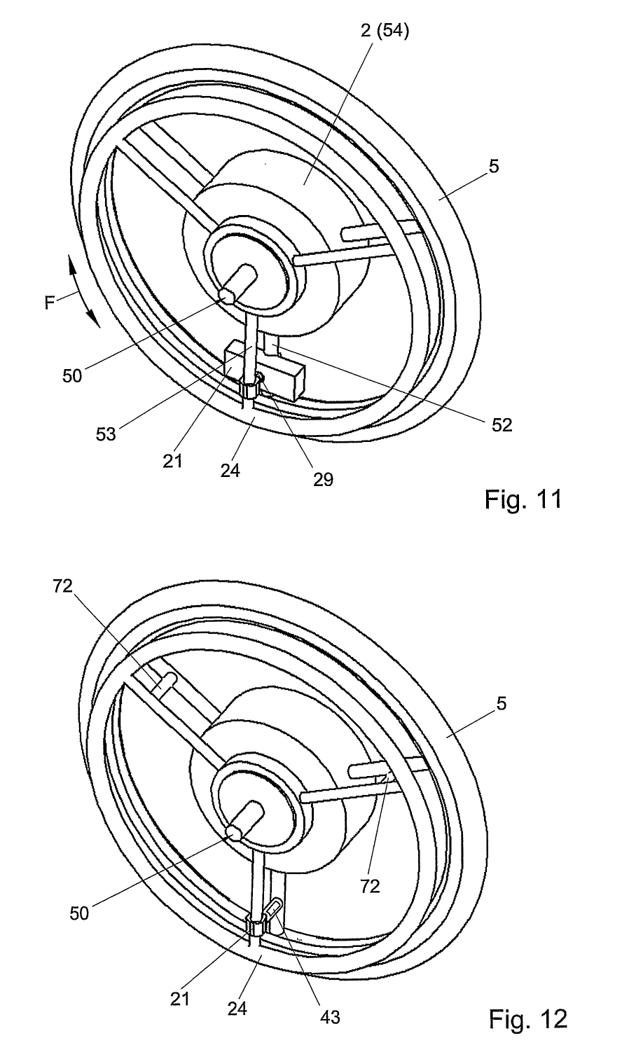

In FIGS. 1A and 2A, as sensor 21, a hand force sensor is mounted on a wheel 5 as will be further elucidated with reference to FIG. 11. This sensor is mounted on or near, or is a part of, a wheel 5 and/or a push rim 24 mounted thereon. When a user applies force to the push rim 24, a relatively small angular displacement of the push rim relative to the wheel 5 is obtained, which is detected by the sensor 21. Depending on the force that is applied, this angular displacement will be greater or smaller, which is registered and converted by the sensor into a signal which is transmitted to the controller. Here, the algorithm mentioned can be set such that a higher signal strength and hence a greater applied force leads to a higher voltage supplied to the or a motor. This can be either a proportional relation or another preselected, for instance exponential, reversely proportional relation or the like. Preferably, this can be set per user, for instance in the memory means, as can the absolute relationship between the applied force and, for instance, power and, hence, driving speed.

Preferably, both push rims 24 are equipped with a sensor 21, so that steering of the wheelchair by the sensors can be regulated and supported too.

In FIGS. 1B and 2B, a second embodiment of a wheelchair 1 according to the invention is shown, wherein however a hand force sensor 21 is provided on each of the push bars 11, at least grips 12.

In FIGS. 1C and 2C, a third embodiment of a wheelchair 1 according to the invention is shown, wherein, however, the sensors have been replaced with a system component, in particular a control element 21 in the form of a joystick 21 provided on an arm rest 10 and which is detachably and/or wirelessly coupled to the controller 18.

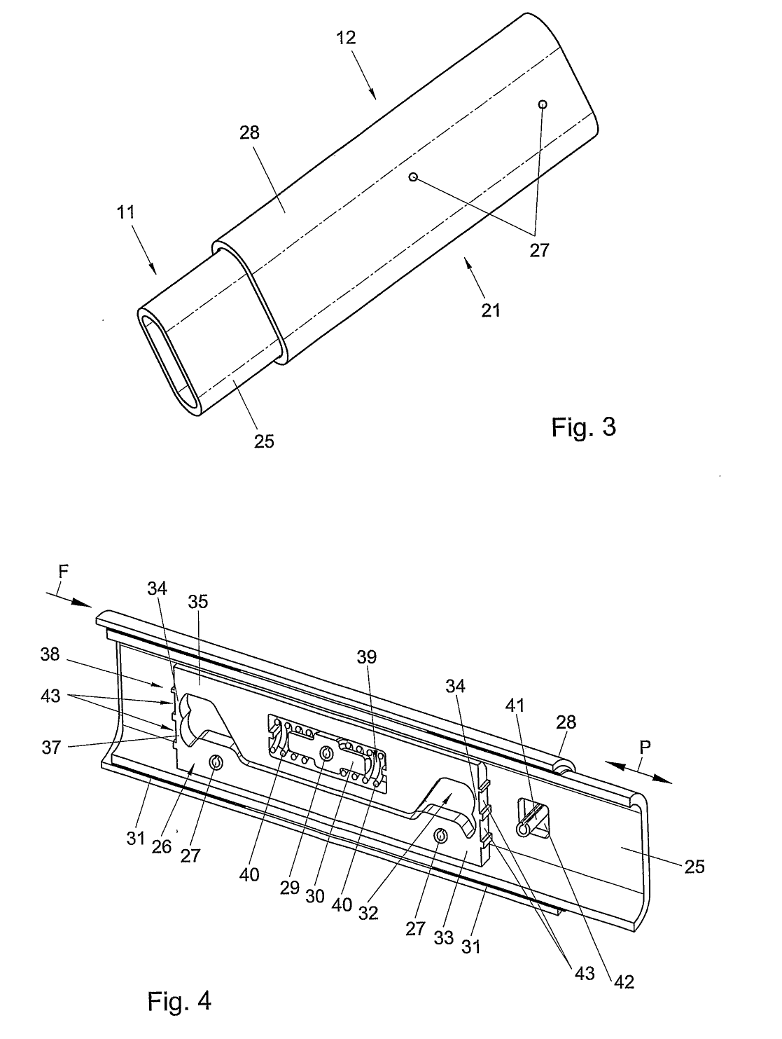

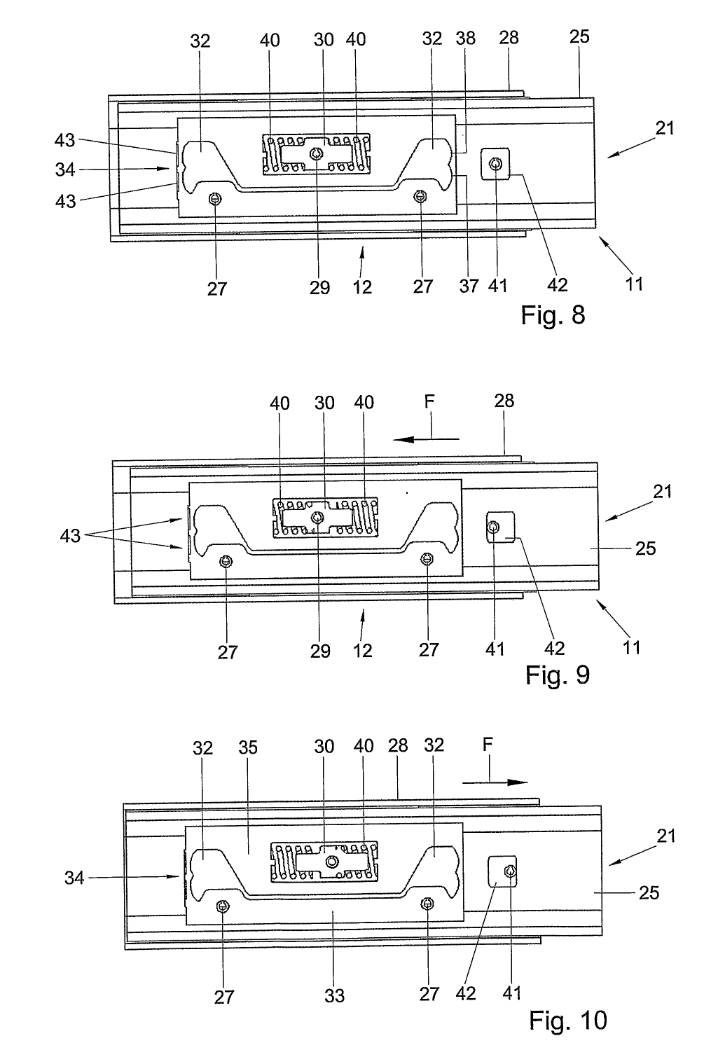

FIGS. 3 and 4 show, in perspective view and cross-sectional longitudinal view, respectively, a sensor 21 according to the invention in an advantageous embodiment. In this embodiment, the sensor 21 can be used as a hand force sensor. The hand force sensor 21 in its neutral position, without a longitudinal force being applied on the grip 12, is represented in FIG. 8. The hand force sensor 21 comprises three main elements, i.e. a part of a tube 25 of the push bar 11 as frame element, a sensor body 26 attached with pins 27 in the tube 25, and a sleeve 28 serving as hand grip 12. The sleeve 28 can slide over the tube 25 and is connected to a spring element 30 by means of a pin 29. Between the tube 25 and the sleeve 28 a sliding bearings 31 can be provided. An advantageous method is to use PTFT adhesive tape.

Via a cut out profile 32, the sensor body 26 is divided into a first part, to be called a stationary part 33, two resilient bending bars 34 and a second part to be called spring holder part 35. In the spring holder part 35, a spring opening 39 is provided in which the spring element 30 is placed. Between the spring element 30 and the spring holder part 35, at two opposite sides of the spring element 30, springs 40 are provided. The sleeve 28 is further provided with a pin 41 which fits into a stop opening 42 in the tube 25, and which bounds the furthest admissible positions of the sleeve as will be further shown in FIGS. 8-10.

On the sensor body 26, at least one strain gauge 43 is provided on the bending bar 34. The sensor body 26 is fixedly connected, by the lower stationary part 33, with pins 27, to the tube 25, while the spring element 30 is fixedly connected by the pin 29 to the sleeve 28, which pin reaches through a slotted hole in the tube 25. When the tube 28 moves in longitudinal direction P relative to the tube 25, as a result, the spring element 30 will move relative to the tube 25 in the same direction P. This will cause the spring 40 leading in the direction of movement P to be slightly compressed, the spring located at the opposite side will be lengthened or maintain the same length. Moreover, the spring holder part 35 will move along relative to the stationary part 33 thereby bending the bending bars 34.

The geometry of the resilient bending bars 34 is selected such that when the spring holder part 35 moves, the bending bars 34 are bent in an S-shape so that at a lower part 37 of a bending bar 34 proximal to the stationary part 33, a butt is formed and, at the opposite, upper part 38 of the same bending bar 34 at the outside, an elongation is formed. With the other bending bar 34, the effect will be reversed. Or vice versa, depending on the direction of movement P.

At the locations where the butt or the elongation, respectively, are formed, strain gauges 43 are provided which are sensitive to the butt or the elongation, respectively, and which, as a result thereof, exhibit a proportional resistance change. The strain gauges 43 are included in a Wheatstone bridge and with this, an electronic signal can be obtained which is proportional to the deformation of the bending bar 43.

In case the sensor body 26 is equipped with two strain gauges 43, the half Wheatstone bridge is complemented by two resistances, when the sensor body is provided with strain gauges 43 on both bending bars, these can be included in a complete Wheatstone bridge. This has as an advantage that the sensitivity is enhanced.

During use, a hand force F on the sleeve 28 is transmitted via pin 29 to the spring element 30. The spring element 30 is located in the spring opening 39 and, via the springs 40, applies the hand force F to the spring holder part 35, causing an elastic deformation of the bending bars 34. The rigidity of the spring is 40 is selected such that the occurring displacement of the sleeve 28, with the maximum desired ergonomic hand force F for propelling the wheelchair 1, causes a spring force which, in the sensor body 26, causes the bending bars 34 to bend, which bending produces an electric signal proportional to the hand force F that can be used for controlling the traction motors 2 of the drive unit 17. In the case the hand force F wants to push the chair forward in a driving direction R (see FIG. 1), an electric signal is delivered controlling the electric motor(s) 2 such that a drive force is generated which supports the hand force F. In case the hand force F wants to pull the wheelchair backwards, the sensor 21 delivers a reverse signal, causing the direction of revolution of the traction motors(s) to reverse and, again delivering a drive force which supports the pulling hand force.

In FIGS. 8-10, three positions of a sensor 21 are shown, in cross-sectional view. In FIG. 8, the sensor 21 is shown in a neutral position. Here, the spring element 30 is in the middle of the spring opening 39 and the springs 40 have a similar, neutral position. The spring holder part 35 is straight above the stationary part 33, and the bending bars 34 have been brought into a neutral, straight position. This position indicates that no force F is applied to the sleeve 28, so that no control signal is transmitted to the controller, at least a zero signal.

In FIG. 9, a force F is applied to the grip 12, at least to the sleeve 28, to the left hand side in the plane of the drawing. As a result, the spring element 30 is moved to the left in the spring opening 39, thereby compressing the left hand spring 40. In FIG. 9, the maximum deflection is shown, with the pin 41 running into the wall of the opening 42. It will be clear that here, the bending bars 34 are bent as earlier described so that the strain gauges 43 produce a maximum electric signal.

In FIG. 10, the position is shown in which a force F is applied to the sleeve 28 in the direction F opposite to the one shown in FIG. 9, to the right hand side in the plane of the drawing. As a result, the spring element 30 is moved to the right, while compressing the spring 40 located on the right-hand side. Again, the maximum deflection is shown, with the pin 41 abutting against the wall of the opening 42. Again, a bending bar 34 is bent maximally, so that the strain gauges 43 will produce a maximum electric signal. This electric signal will, for instance, be as large but opposite to the electric signal produced in the position of FIG. 9.

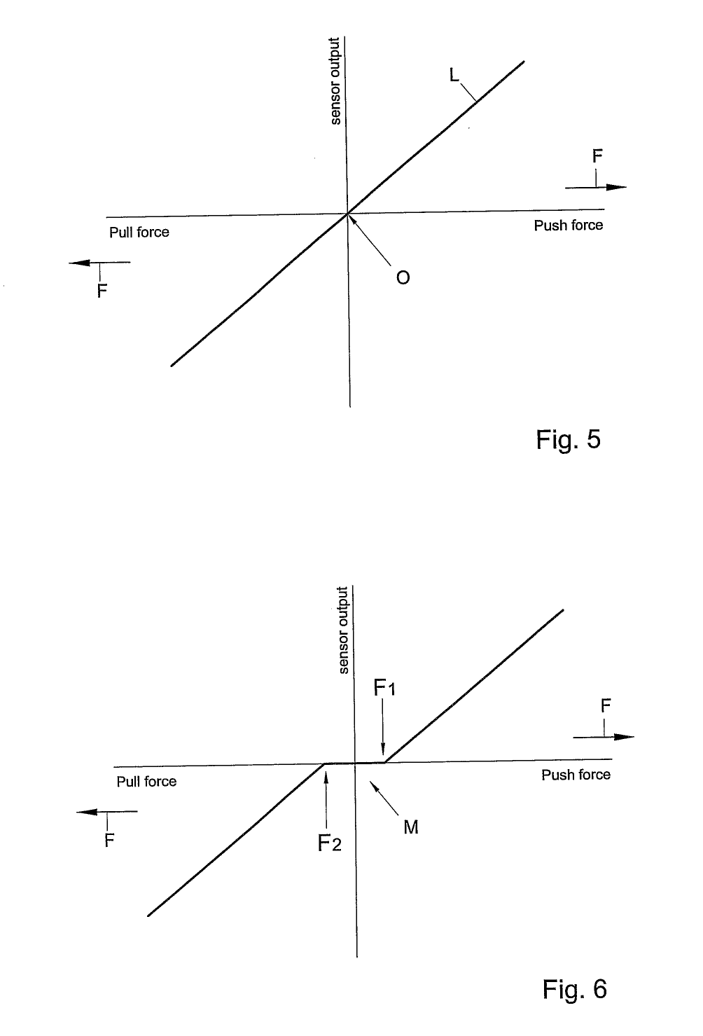

In FIG. 5, schematically, an example of the output of a sensor with different loads is given. Along the vertical line, the sensor output is given, for instance as electric voltage, optionally amplified by a suitable amplifier. From zero point O upwards, for instance, a positive voltage is given, downward a negative voltage. Along the horizontal axis, the force is represented, on the right hand side of the zero point O as a push force, i.e. a force F in the driving direction R, on the left hand side a pull force F, i.e. opposite to the driving direction R. In FIG. 5, the relation between the sensor output and the force F is represented as a linear relation, represented by the line L. Naturally, through for instance a suitable choice of the springs 40, this can also be a different relation, for instance with an increase of the force F a relatively smaller increase of the sensor output, or the reverse.

In FIG. 6, again, an example of the sensor output is shown in relation to the push-pull force F, the characteristic however being adapted by the controller 18. Here, in a center area M adjacent the neutral position of the sensor 21 as shown in FIG. 8, the characteristic has been adapted such that when the force F changes, no sensor output is generated, at least is not transmitted to the motor unit 17. Only when a threshold value F¹, F² is exceeded, when the force F increases, the increase of the sensor output will follow. Consequently, support buy the user will only occur when more than a boundary force is required for pushing or pulling, respectively, the wheelchair.

If a push rim has been mounted to the wheels of the chair, with a deformable bending bar, in a similar manner, a control signal proportional to the hand force is obtained. To that end, on the wheel, a push rim 24 is provided which is pivotally attached to the wheel axis 50 or driving motor. This pivotal movement bears on the force sensor 21 which operates in a similar manner as the hand force sensor on the pushing bars as shown and described in FIGS. 3 and 4, i.e. in that the hand force F is transmitted via a spring 40 onto the sensor body 26 so that use is made of the spring path of the springs 40 to realize a controllable force and an acceptable displacement of the push rim 24 to a stop. To this end, for instance, a stationary part 33 is attached to a spoke 52 of the wheel 5, and the pin 29 is connected to a spoke 53 of the push rim such that a relative movement of the two spokes can be obtained and can be detected and can be converted into a related electric signal.

In FIG. 11, an example is given of a push rim which is pivotally bearing mounted onto a hub motor 54 and, via a coupling pin 29, is connected to the force sensor 21. The force sensor 21 in this embodiment is preferably equipped with a wireless signal transmission via a transmitter/receiver which transmits the hand force signal on the push rim 24 to the controller 18.

Alternatively, the push rim 24 can be connected via a fixed axis to the wheel 25, while on the axis 50 at least one strain gauge 43 is provided with which the torsion in the axis 50 is measured, as measure for the hand force applied to the push rim 24.

Also, the push rim 24 can be connected to the wheel 5 via a number of resilient elements, for instance leaf springs, and a sensor 21, as shown in FIG. 12. It is preferred that, in the direction of rotation, the resilient elements 72 have a rigidity smaller than that of the sensor, for instance 90% or less, more in particular less than 50% and, preferably, between 5 and 15%, for instance approximately 10% of the rigidity of the sensor 21 in direction of rotation. Again, strain gauges 43 are provided on the sensor 21 so that bending in the sensor in the direction of rotation of the wheel 5 can be measured, while, as a result of the relatively rigid sensor 21, the push rim 24 will virtually not move relative to the wheel 5. Many variations thereon will be directly clear to the skilled person.

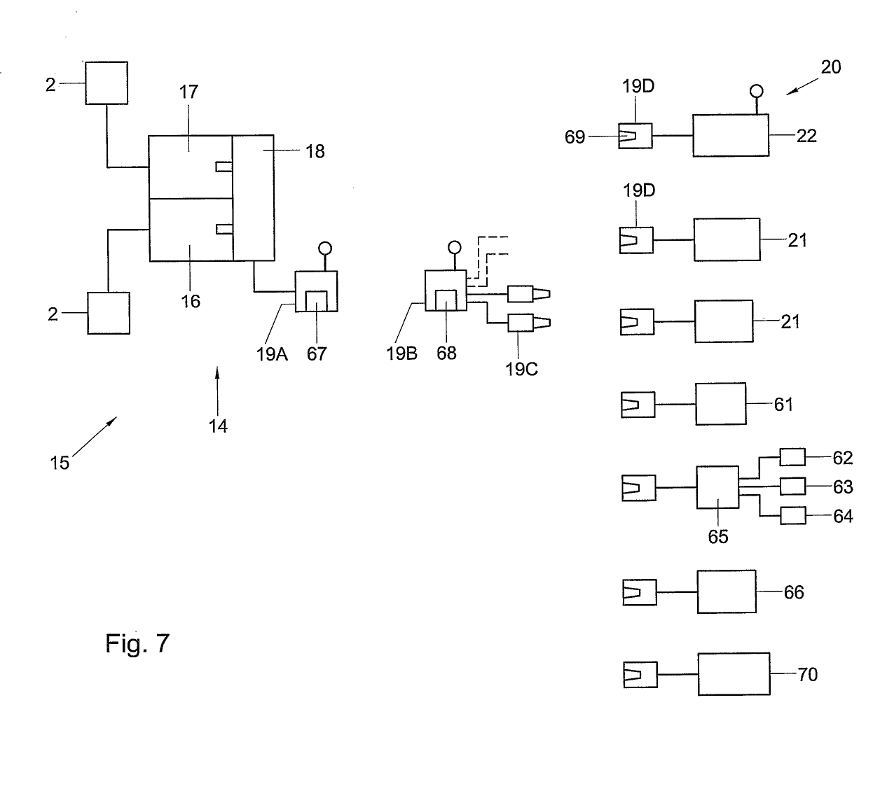

In FIG. 7, schematically, a block diagram of a drive system 15 of a wheelchair 1 according to the invention is shown, comprising the basic component 14 and a series of sensors 21 and an operating element 20, as well as other electric and/or electronic components as will be further elucidated.

The controller 18 is connected to a coupling means 19A, in the embodiment shown in the form of a transmitter/receiver, with an electronic encoding 67. A second coupling means 19B, again in the form of a transmitter/receiver is provided with a second electronic encoding 68, compatible with the electronic encoding 67, so that the two coupling means 19A and 19B can only communicate with each other in a wireless manner. Here, for instance blue tooth uses or such systems can be considered. In the embodiment shown, the second coupling means 19B is provided with a number of plugs 19C that can be coupled to female plugs 19D of different operating systems 20, sensors 21 and/or the further electronic or electric components mentioned. Naturally, these female coupling means 19D can also be designed as the second coupling means 19B, while the plugs mentioned are omitted. In that case, each female coupling means 19D will be provided with an electronic encoding 69, specific to the respective operating means 20, the sensor 21 and/or the electronic/electric component and to the first coupling means 19A, at least the encoding 67. Thus, it is ensured that, each time, the controller 18 can recognize the respective component and will react only thereto.

In FIG. 7, as an example of an operating element 20, a joystick 22 is provided, as example of sensors 21 a push force sensor to be placed on a grip 12 and a hand force sensor to be placed on a push rim 24. Further, a GPS unit 61 is shown, which is suitable for transmitting the position of the wheelchair 1. Further, three motors 62, 63, 64 are shown, for adjusting the leg rest, the back rest and the seat of the wheelchair, respectively. These motors can be controlled via, for instance, a second controller 65 so that for a user, each time, a suitable position can be set. Further, a data base 66 is provided, in which data relating to the user can be stored, such as medical data and data relating to the use of the wheelchair, for instance sitting settings, maximum allowable speeds, driving behaviour and the like.

Further, an alarm 70 is provided with which automatically or on the initiative of a user, an alarm signal can be produced, for instance to an operator, if a situation has arisen which is undesirable to the user. If also a GPS module 61 is coupled to the controller 18, then, the position of the user can be directly transmitted.

As a result of the modular structure of the control system 15 according to the invention, the different components 20, 21, 61-66 and 70 can be used, at wish, in any desired combination on a wheelchair 1 according to the invention, depending on, for instance, the wishes of a user. It is preferred that in the controller 18, an algorithm is included with which a suitable control of the motors can be set, depending on the selection of the components coupled thereto. Preferably, in the controller 18, a database is included with the different encodings 67,68, 69, so that each individual component can be directly recognized and the controller can be adapted thereto.

Instead of the coupling means 19A, 19B, and/or 19A, 19B designed as transmitter/receiver, naturally, plug connections can be used too for coupling the different components to the controller 18. However, wireless communication offers the advantage of improved simplicity and renders the necessity of using, for instance, slide couplings and the like superfluous.

In FIG. 1, in each of the embodiments of the wheelchair 1, a spring-loaded switch 71 is provided which can be indicated as a suppression switch. With this switch 71, via the controller 18, at least temporarily, the function of at least one of the sensors 21 and/or operating means 20, such as the joystick 22, can be taken over, at least overruled. By pushing the switch 71, for instance the or each motor 2 can be driven at a constant speed, with a constant power or a constant torque, so that, for instance, passing obstacles with the wheelchair can be simplified. The fact is that if this were done (exclusively) by applying a force F to the grips 12 and/or the push rim 24, the drawback would arise that with this, the sensors 21 are operated, thus causing an undesired drive characteristic. Moreover, pushing the wheelchair via the grips leads to an increase of the pressure on the front wheels. By energizing the suppression switch, the motor is powered and this effect is avoided, so that the front wheels can simply be brought over obstacles such as a threshold, for instance by tilting the back of the wheelchair slightly downwards. Through the use of the switch 71 this is prevented in a simple manner. The switch 71 can for instance be placed next to a wheel 5 as shown in FIG. 1A, near the grips 12 as shown in FIG. 1B or near an arm rest 10 as shown in FIG. 1C. Naturally, also, several of these switches 71 can be provided or they can be provided on different locations. Placing the switch 71 near one side of the wheelchair 1 then offers the advantage that an assistant can stand next to the wheelchair 1 during operation. Consequently, eye contact between an assistant and a user of the wheelchair 1 is still further simplified.

The invention is not limited in any manner to the embodiments represented in the description and the drawings. Many variations thereon are possible within the framework of the invention as outlined by the claims.

For instance, several operating components can be combined and other hand force sensors than those shown can be used on, for instance, the pushing bars and/or push rims. Naturally, a wheelchair according to the invention can have a different structure, which structure is chosen depending on the intended use and the intended user. For instance, a different number of wheels can be used and other sitting or lying supports can be used. It is preferred that a wheelchair according to the invention is at least partly designed to be modular, so that it can be relatively easily adjusted to different users. Naturally, the characteristics of the controller can be set at wish and are preferably adjustable with the aid of for instance a computer, from a database, so that for each individual user a characteristic can be set, which, moreover, can simply be designed to be self-learning.

1: A wheelchair, provided with a drive system comprising a controller, an energy source and driving motors and sensors that can be coupled thereto for measuring a control signal for the driving motors.

2: A wheelchair according to claim 1, wherein the drive system is of modular structure and comprises at least two different sensors.

3: A wheelchair according to claim 1, wherein the or each sensor and the controller are equipped with a transmitter and/or receiver designed for sending said control signals to the controller.

4: A wheelchair according to claim 1, wherein the sensors have a unique code which, during use, is recognized in the controller.

5: A wheelchair according to claim 1, wherein at least the drive system is of modular structure such that different system components can be exchanged in a simple manner.

6: A wheelchair according to claim 1, wherein the drive system comprises a series of sensors identifiable by an electronic code, the controller being provided with recognition means for said electronic codes in order to cooperate with all system components.

7: A wheelchair according to claim 1, wherein the controller is coupled, at least can be coupled, to adjusting motors and switches for adjusting the sitting position, back rest, arm rest and/or leg rests.

8: A wheelchair according to claim 1, wherein the controller is provided with means for sending an alarm signal, in case of emergency, and/or transmitting the position of the wheelchair by means of GPS coordinates.

9: A wheelchair according to claim 1, wherein the drive system is provided with force sensors for measuring the hand force for driving the wheelchair.

10: A hand force sensor comprising a force sensitive sensor part and a spring system which, during use, transmits hand force from a grip or wheel to which the hand force is applied, to the force sensor.

11: A hand force sensor according to claim 10, wherein the spring system comprises two biased springs between which a receiver element is provided which, during use, transmits the hand force to the spring system.

12: A hand force sensor according to claim 10, wherein movement of the grip to which the sensor, at least the receiver element, is connected is bound by a stop so that overload of the force sensitive sensor is prevented.

13: A hand force sensor according to claim 10, wherein the hand force sensor is coupled to a signal amplifier such that a signal, measured by the hand force sensor, can be transmitted to a controller of a wheelchair drive system.

14: A hand force sensor according to claim 10, provided with means for placement on a push bar of a wheel chair such that during use, hand force applied to the push bars can be measured with the or each hand force sensor.

15: A hand force sensor according to claim 10, wherein the hand force sensor is provided with means for placement on a push rim of a wheelchair such that during use, hand force applied to the push rim can be measured with the force sensor.

16: A drive system for a wheelchair according to claim 1 and provided with a hand force sensor comprising a force sensitive sensor part and a spring system which, during use, transmits hand force from a grip or wheel to which the hand force is applied, to the force sensor.

17: An assembly of a wheelchair according to claim 1 and a series of hand force sensors, compatible with a controller of said wheelchair, wherein, at wish, a hand force sensor can be placed on a push bar of the wheelchair or on a push rim of the wheelchair for measuring the hand force applied to said at least one push grip and/or said at least one push rim.

18: A method for the use of an electrically driven or supported wheelchair, wherein from a series of force sensors and components of a drive system a selection is made, depending on limitations of an intended user, while a basic component comprising at least one battery set, a driving motor and a controller has been or is provided on a wheelchair and the or each selected force sensor and/or the or each selected component of the drive system is provided on the wheelchair and is coupled to the controller, whereupon the wheelchair is driven by the user and this drive is supported by the basic component, based on force applied to the or each force sensor.

19: A wheelchair according to claim 1, wherein a suppression switch is provided.

20: A hand force sensor according to claim 1, via a wire and/or via a transmitter and receiver on the controller.

21: A hand force sensor according to claim 1, such that during use, hand force applied to the push rims of the wheels can be measured with each hand force sensor.

22: A drive system for a wheelchair according to claim 10 provided with a hand force sensor.
